(19) United States
(12) Patent Application Publication
(10) Pub. No.: US 2025/0334148 A1
(43) Pub. Date: Oct. 30, 2025

(54) AXIAL RETENTION ASSEMBLY FOR AXIALLY FIXING ROTATING PARTS WITH RESPECT TO EACH OTHER

(71) Applicant: Schaeffler Technologies AG & Co. KG, Herzogenaurach (DE)

(72) Inventors: Joshua HALVORSEN, Wooster, OH (US); David AVINS, Burbank, OH (US); Austin HOFF, New Franklin, OH (US)

(21) Appl. No.: 18/648,002

(22) Filed: Apr. 26, 2024

(51) Int. Cl. F16C 13/00

(52) U.S. Cl. CPC F16C 13/00

(57) ABSTRACT

An axial retention assembly for axially fixing rotating parts together includes a retainer ring including: a ring section; a set of first fingers each extending from the ring section radially in a first direction with respect to the center axis of the ring section; and a set of second fingers each extending from the ring section radially in the first direction with respect to the center axis of the ring section, free ends of each of the second fingers being axially spaced from free ends of the first fingers; a first part having a first circumferential surface and a first groove formed in the first circumferential surface, the free ends of the first fingers being received in the first groove; and a second part having a second circumferential surface, the second cylindrical surface having a second groove, the free ends of the second set of fingers being received in the second groove, the retainer ring holding the second part axially in place on the first part to prevent the second part from being movable in both axial directions.

### TECHNICAL FIELD

The present disclosure relates to rotating parts in automotive drivetrains, and more specifically to device for axially fixing two rotating parts together in automotive drivetrains.

### BACKGROUND

Snap rings are often used to axially fix rotating parts together in automotive drivetrains.

### SUMMARY

An axial retention assembly for axially fixing rotating parts together is provided. The assembly includes a retainer ring including: a ring section; a set of first fingers each extending from the ring section radially in a first direction with respect to the center axis of the ring section; and a set of second fingers each extending from the ring section radially in the first direction with respect to the center axis of the ring section, free ends of each of the second fingers being axially spaced from free ends of the first fingers; a first part having a first circumferential surface and a first groove formed in the first circumferential surface, the free ends of the first fingers being received in the first groove; and a second part having a second circumferential surface, the second cylindrical surface having a second groove, the free ends of the second set of fingers being received in the second groove, the retainer ring holding the second part axially in place on the first part to prevent the second part from being movable in both axial directions.

In examples, the retainer ring is formed of a sheet of metal having a uniform thickness.

In examples, the ring section defines an outermost circumferential surface of the retainer ring.

In examples, the second fingers defines an innermost diameter of the retainer ring.

In examples, the second fingers extend radially further from the ring section than the first fingers.

In examples, the retainer ring further includes a plurality of circumferentially spaced webs connected to the ring section, the second fingers being connected to the ring section by the webs.

In examples, each of the fingers is connected to the ring section by two of the webs.

In examples, each of the webs connects two of the fingers to the ring section.

In examples, the first fingers are directly connected to the ring section, and the webs are directly connected to the ring section.

In examples, the webs extend at a first angle from the ring section.

In examples, the first angle is between 30 to 60 degrees.

In examples, the retainer ring further includes a plurality of slots that are circumferentially spaced apart from each other by the webs, an inner circumferential surface of each of the slots being defined by a respective one of the second fingers, each of the webs includes a first axially and radially extending surface that faces a first circumferential direction and a second axially and radially extending surface that faces a second circumferential direction, the first axially and radially extending surface of each web defining a first circumferential edge of one of the slots, the second axially and radially extending surface of each web defining a second circumferential edge of another of the slots.

In examples, a first radially inner edge of each first axially and radially extending surface of each web and a second radially inner edge of each second axially and radially extending surface of each web directly connects to the ring section, a base end of each of the first fingers being directly circumferentially between the first radially inner edge of one of the webs and the second radially inner edge of another of the webs.

In examples, each of the second fingers includes a first circumferentially facing surface facing in the first circumferential direction and a second circumferentially facing surface facing in the second circumferential direction, the first circumferentially facing surface of each second finger extending from the free end of the second finger to an outer circumferential surface of one of the webs, and the second circumferentially facing surface of each second finger extending from the free end of the second finger to an outer circumferential surface of another of the webs, wherein each of the fingers includes a first extension directly connecting the finger to the one of the webs and a second extension directly connecting the finger to the other one of the webs, the first extension being defined by part of the first circumferentially facing surface of the respective finger and a part of the second axially and radially extending surface of the one of the webs, the second extension being defined by part of the second circumferentially facing surface of the respective finger and a part of the first axially and radially extending surface of the one of the webs.

In examples, each of the first fingers is axially aligned with a respective one of the slots.

In examples, the ring section includes a first planer surface that faces in a first axial direction and a second planer surface that faces in a second axial direction, each of the first fingers including a first planer surface that faces in the first axial direction and a second planer surface that faces in the second axial direction, the first planar surface of each of the first fingers being contiguous with the first planar surface of the ring section, the second planar surface of each of the second fingers being contiguous with the second planar surface of the ring section, wherein the first planar surface of each of the first fingers and the first planar surface of the ring section extend in a first plane, and the second planar surface of each of the first fingers and the second planar surface of the ring section extend in a second plane.

A method is also provided for creating an axial retention assembly including a retainer ring, a first part having a first circumferential surface and a second part having a second circumferential surface, the retainer ring including a ring section, a set of first fingers each extending from the ring section radially in a first direction with respect to the center axis of the ring section; and a set of second fingers each extending from the ring section radially in the first direction with respect to the center axis of the ring section. The method includes installing the retainer ring onto the first part and the second part to cause the first fingers to snap into the first groove of the first part and to cause the second fingers to snap into the second groove of the second to prevent axial movement on both axial directions.

In examples, the method further includes stamping a steel sheet to form the ring section, the first fingers and the second fingers; and bending the steel sheet to cause the second fingers to move axially with respect to the ring section and the first fingers the retainer ring to cause free ends of each of the second fingers to be axially spaced from free ends of the first fingers, the bending of the steel sheet including bending the steel sheet at a junction between the webs and the ring section.

A retainer ring is also provided for axial fixing a first part and a second part with respect to each other to prevent the second part from being movable in both axial directions with respect to the first part, the retainer including: a ring section; a set of first fingers each extending from the ring section radially in a first direction with respect to the center axis of the ring section; and a set of second fingers each extending from the ring section radially in the first direction with respect to the center axis of the ring section, free ends of each of the second fingers being axially spaced from free ends of the first fingers; the free ends of the first fingers confirmed for being received in a first groove in a first circumferential surface of the first part, the free ends of the second fingers confirmed for being received in a second groove in a second circumferential surface of the first part.

A method of forming the retainer rings is also provided that includes stamping a steel sheet to form the ring section, the first fingers and the second fingers; and bending the steel sheet to cause the second fingers to move axially with respect to the ring section and the first fingers the retainer ring to cause free ends of each of the second fingers to be axially spaced from free ends of the first fingers.

### A BRIEF DESCRIPTION OF THE DRAWINGS

The present disclosure is described below by reference to the following drawings, in which:

FIG. 1 shows a perspective view a retainer ring in accordance with the present disclosure;

FIG. 2a shows a radially facing cross-sectional view of the retainer ring shown in FIG. 1 axially fixing a first part, in the form of a shaft, and a second part, in the form of a shaft, together;

FIG. 2b shows enlarged view of the radially facing cross-sectional view shown in FIG. 2a;

FIG. 3 shows a radially facing cross-sectional view of another example of a retainer ring in accordance with the present disclosure.

### DETAILED DESCRIPTION

Rotatable parts in automotive drivetrains that are fixed together by snap rings only restrict movement in one axial direction. The present retainer ring prevents axial movement in both directions between two rotatable parts. The retainer ring can be manufactured using a stamping process.

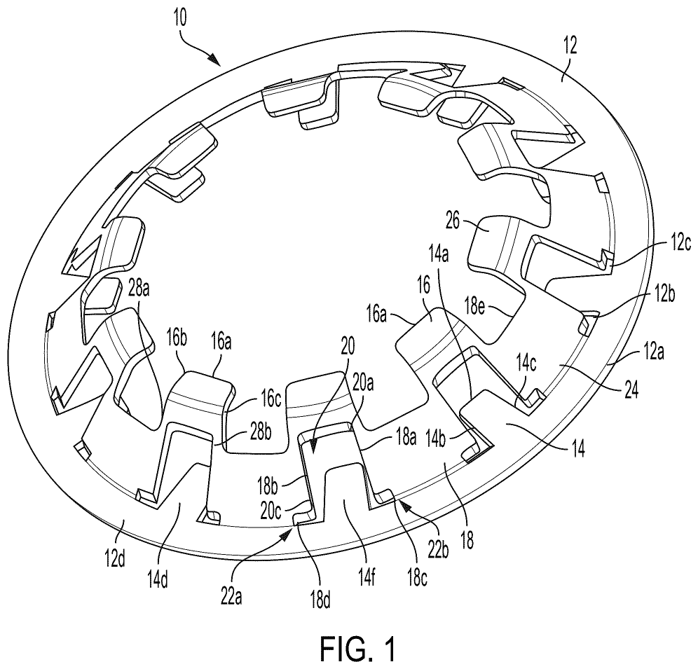

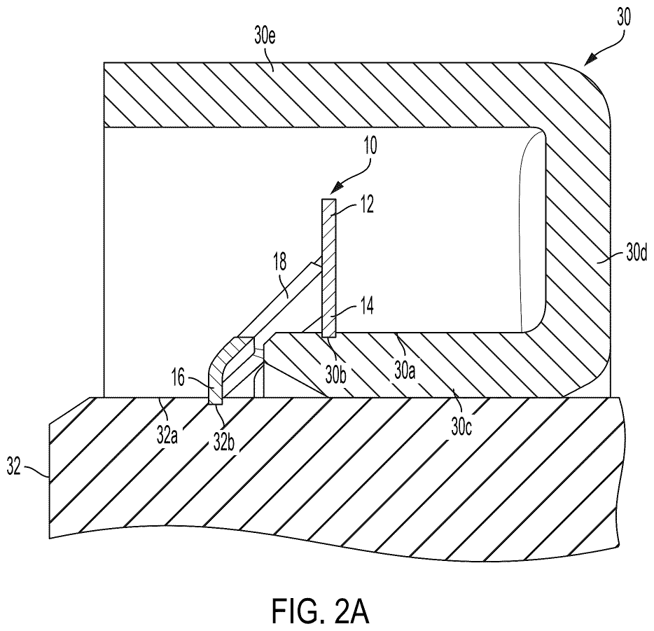

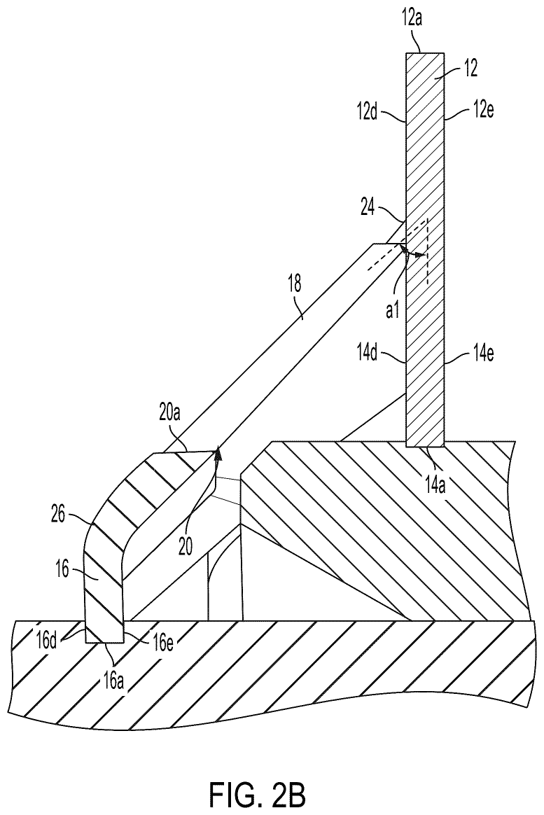

FIGS. 1 to 2b show different views of a retainer ring 10 in accordance with the present disclosure. The retainer ring 10 includes a ring section 12, a set of first fingers 14, and a set of second fingers 16. The first fingers 14 extend radially from the ring section 12 in a first direction with respect to the center axis CA of the retainer ring 10, and the second fingers 16 also extend radially in the first direction with respect to the center axis CA of the retainer ring 10. Free ends 14a of the first fingers 14 are axially spaced from the free ends 16a of the second fingers 16.

The retainer ring 10 further includes a plurality of webs 18 that connect the second fingers 16 to the ring section 12, with each of webs 18 having a first axially and radially extending surface 18a facing in a first circumferential direction and a second axially and radially extending surface 18b facing in a second circumferential direction. Webs 18 are bent axially away from the ring section 12 at bends 24 that form junctions between the ring section 12 and the webs 18. The ring section 12 includes an outer circumferential surface 12a that defines an outermost circumferential surface of retainer ring 10 and an inner circumferential surface from which first fingers 14 and webs 18 radially extend. Specifically, the first fingers 14 are positioned between a first inner circumferential surface section 12b of ring section 12 and a second inner circumferential surface section 12c of ring section 12.

The first fingers 14 are directly connected to the ring section 12 and include a first circumferentially facing and radially extending surface 14b and a second circumferentially facing and radially extending surface 14c. The second fingers 16 are connected to the ring section 12 by the webs 18 and include a first axially and radially extending surface 16b facing in the first circumferential direction and a second axially and radially extending surface 16c facing in the second circumferential direction. Second fingers 16 include bends 26 that cause fingers 16 to extend radially inward at free ends 16a. The webs 18 are circumferentially spaced apart from each other and extend at a first angle al (FIG. 2b) from the ring section 12, with a web 18 connecting two of the fingers 14, 16 to the ring section 12. The retainer ring 10 also includes a plurality of slots 20 that are circumferentially spaced apart from one another by the webs 18, with an inner circumferential surface 20a of a slot 20 being defined by a respective one of the second fingers 16. Slots 20 each includes two circumferentially extending notches 22a, 22b that extend in opposite circumferential directions away from the respective first fingers 14 and each into a respective web 18.

The first axially and radially extending surface 18a of web 18 defines a first circumferentially facing surface 20b of one of the slots 20, and the second axially and radially extending surface 18b of web 18 defines a second circumferentially facing surface 20c of another of the slots 20. A first radially inner edge 18c of the first axially and radially extending surface 18a and a second radially inner edge 18d of the second axially and radially extending surface 18b directly connect to the ring section 12, with a base end 14f of the first fingers 14 being directly circumferentially between the first radially inner edge 18c of one of the webs 18 and the second radially inner edge 18d of another of the webs 18.

The first circumferentially facing surface 16b of each of the second fingers 16 extends from the free end 16a of the second finger 16 to the inner circumferential surface 18e of one of the webs 18, and the second circumferentially facing surface 16c of the second fingers 16 extends from the free end 16a to the inner circumferential surface 18e of another of the webs 18. The second fingers 16 each include a first extension 28a directly connecting the second finger 16 to one of the webs 18 and a second extension 28b directly connecting the second finger 16 to another one of the webs 18. The first extension 28a is defined by part of the first circumferentially facing surface 16b of the respective second finger 16 and a part of the second axially and radially extending surface 18b of the one of the webs 18, and the second extension 28b is defined by part of the second circumferentially facing surface 16c of the respective second finger 16 and a part of the first axially and radially extending surface 18a of the one of the webs 18.

The ring section 12 includes a first planar surface 12d that faces in a first axial direction and a second planar surface 12e (FIG. 2b) that faces in a second axial direction. The first fingers 14 include a first planar surface 14d that faces in the first axial direction and a second planar surface 14e that faces in the second axial direction. The first planar surface 14d of the first fingers 14 is contiguous with the first planar surface 12d of the ring section 12, and the second planar surface 14e of the first fingers 14 is contiguous with the second planar surface 12e of the ring section 12. The first planar surface 14d of the first fingers 14 and the first planar surface 12d of the ring section 12 extend in a first plane, and the second planar surface 14e of the first fingers 14 and the second planar surface 12e of the ring section 12 extend in a second plane that is parallel to the first plane.

As illustrated in FIGS. 2a and 2b, the retainer ring 10 is configured for engaging a first part in the form of a carrier 30 and a second part in the form of a shaft 32. The shaft 32 and the carrier 30 are non-rotatably connected together, for example by splines on the outer circumference of the shaft 32 engaging with splines on the inner circumference of the carrier 32, so that carrier 30 and shaft 32 are rotatable together. The first fingers 14 are engaged within a first groove 30b located on the outer circumferential surface 30a of the first part 30. The second fingers 16 are engaged within a second groove 32b located on the outer circumferential surface 32a of second part 32. This engagement of the fingers 14, 16 within the grooves 30b, 32b prevents axial movement of the first part 30 relative to the second part 32 in both axial directions.

The free ends 14a of first fingers 14 are received in groove 30b, with first planar surface 14d and second planar surface second planar surface 14e adjacent to the free ends 14a abutting walls of the groove 30b. Similarly, the free ends 16a of second fingers 16 are received in groove 32b, with first planar surface 16d and second planar surface second planar surface 16e adjacent to the free ends 16a abutting walls of the groove 32b.

The carrier 30 includes an axially extending inner hub 30c, a radially extending section 30d extending outward from hub 30c and an axially extending outer section 30e extending radially from axially extending outer section 30e.

In the installed configuration of retainer ring 10 shown in FIGS. 2a, 2b, the retainer ring 10 secures the carrier 30 and the shaft 32 axially together. The design of the retainer ring 10, with first and second fingers 14, 16, prevents axial movement in both axial direction as carrier 30 and shaft 32 are rotated together.

A method for creating the snapping component assembly shown in FIGS. 1a, 2b includes installing the retainer ring 10 onto the carrier 30 and the shaft 32 to cause the first fingers 14 to snap into the first groove 30b of the carrier 30 and to cause the second fingers 16 to snap into the second groove 32b of the shaft 32 to prevent axial movement of the carrier 30 and the shaft 32 with respect to each other in both axial directions.

Prior to installation, the method includes stamping a steel sheet to form the ring section 12, the first fingers 14 and the second fingers 16, and then bending the steel sheet to cause the second fingers 16 to move axially with respect to the ring section 12 and the first fingers 14 to cause free ends 16a of each of the second fingers 16 to be axially spaced from free ends 14a of the first fingers 14. The bending of the steel sheet including bending the steel sheet at a junction between the webs 18 and the ring section 12.

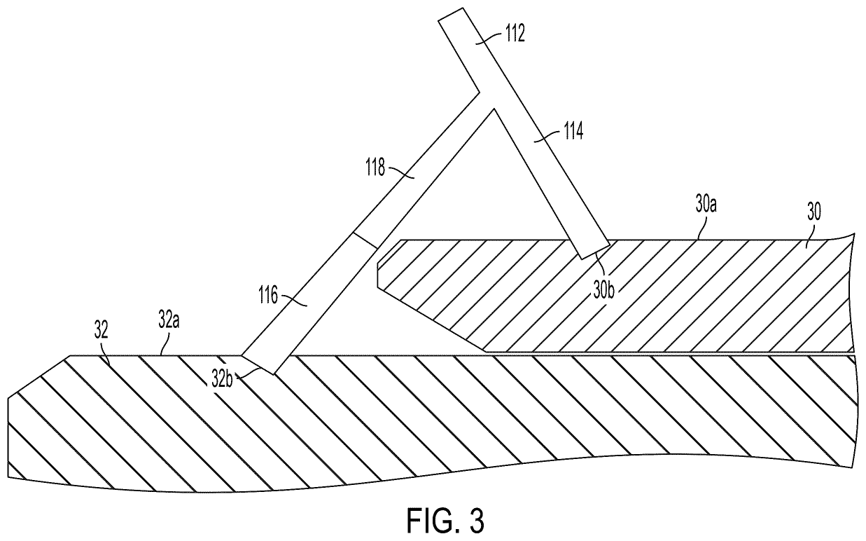

FIG. 3 shows a radially facing cross-sectional view of another example of a retainer ring 110 in accordance with the present disclosure. Retainer ring 110 is configured in substantially the same manner as retainer ring 10, except that second fingers 116 and webs 118 are angled differently with respect to ring section 112 and first fingers 114, and second fingers 116 are not bent into a curved shape. Further, the shape of grooves 30b, 32b are different to accommodate the lack of bending of the second fingers, and the larger angle.

### REFERENCE NUMERALS

10 retainer ring
12 ring section
12a outer circumferential surface
12b first inner circumferential surface section
12c second inner circumferential surface section
12d first planar surface
12e second planar surface
14 first fingers
14a free ends
14b surface
14c surface
14d first planar surface
14e second planar surface
14f base end
16 second fingers
16a free ends
16b first circumferentially facing surface
16c second circumferentially facing surface
16d first planar surface
16e second planar surface second planar surface
18 webs
18a first axially and radially extending surface
18b second axially and radially extending surface
18c first radially inner edge
18d second radially inner edge
18e inner circumferential surface
20 slots
20a inner circumferential surface
20b first circumferentially facing surface
20c second circumferentially facing surface
22a notches
22b notches
24 bends
26 bends
28a first extension
28b second extension
30 carrier
30a outer circumferential surface
30b first groove
30c axially extending inner hub
30d radially extending section
30e axially extending outer section
32 shaft
32a outer circumferential surface
32b second groove
110 retainer ring
112 ring section
114 first fingers
116 second fingers
118 webs

What is claimed is:

1. An axial retention assembly for axially fixing rotating parts together comprising:
a retainer ring comprising:
a ring section;
a set of first fingers each extending from the ring section radially in a first direction with respect to the center axis of the ring section; and
a set of second fingers each extending from the ring section radially in the first direction with respect to the center axis of the ring section,
free ends of each of the second fingers being axially spaced from free ends of the first fingers;
a first part having a first circumferential surface and a first groove formed in the first circumferential surface, the free ends of the first fingers being received in the first groove; and
a second part having a second circumferential surface, the second cylindrical surface having a second groove, the free ends of the second set of fingers being received in the second groove, the retainer ring holding the second part axially in place on the first part to prevent the second part from being movable in both axial directions.

2. The axial retention assembly recited in claim 1, wherein the retainer ring is formed of a sheet of metal having a uniform thickness.

3. The axial retention assembly recited in claim 1, wherein the ring section defines an outermost circumferential surface of the retainer ring.

4. The axial retention assembly recited in claim 1, wherein the second fingers defines an innermost diameter of the retainer ring.

5. The axial retention assembly recited in claim 1, wherein the second fingers extend radially further from the ring section than the first fingers.

6. The axial retention assembly recited in claim 1, wherein the retainer ring further includes a plurality of circumferentially spaced webs connected to the ring section,
the second fingers being connected to the ring section by the webs.

7. The axial retention assembly recited in claim 6, wherein each of the fingers is connected to the ring section by two of the webs.

8. The axial retention assembly recited in claim 7, wherein each of the webs connects two of the fingers to the ring section.

9. The axial retention assembly recited in claim 6, wherein the first fingers are directly connected to the ring section, and the webs are directly connected to the ring section.

10. The axial retention assembly recited in claim 6, wherein the webs extend at a first angle from the ring section.

11. The axial retention assembly recited in claim 10, wherein the first angle is between 30 to 60 degrees.

12. The axial retention assembly recited in claim 6, wherein the retainer ring further includes a plurality of slots that are circumferentially spaced apart from each other by the webs, an inner circumferential surface of each of the slots being defined by a respective one of the second fingers,
each of the webs includes a first axially and radially extending surface that faces a first circumferential direction and a second axially and radially extending surface that faces a second circumferential direction,
the first axially and radially extending surface of each web defining a first circumferential edge of one of the slots,
the second axially and radially extending surface of each web defining a second circumferential edge of another of the slots.

13. The axial retention assembly recited in claim 12, wherein a first radially inner edge of each first axially and radially extending surface of each web and a second radially inner edge of each second axially and radially extending surface of each web directly connects to the ring section,
a base end of each of the first fingers being directly circumferentially between the first radially inner edge of one of the webs and the second radially inner edge of another of the webs.

14. The axial retention assembly recited in claim 12, wherein each of the second fingers includes a first circumferentially facing surface facing in the first circumferential direction and a second circumferentially facing surface facing in the second circumferential direction,
the first circumferentially facing surface of each second finger extending from the free end of the second finger to an outer circumferential surface of one of the webs, and the second circumferentially facing surface of each second finger extending from the free end of the second finger to an outer circumferential surface of another of the webs, wherein each of the fingers includes a first extension directly connecting the finger to the one of the webs and a second extension directly connecting the finger to the other one of the webs,
the first extension being defined by part of the first circumferentially facing surface of the respective finger and a part of the second axially and radially extending surface of the one of the webs,
the second extension being defined by part of the second circumferentially facing surface of the respective finger and a part of the first axially and radially extending surface of the one of the webs.

15. The axial retention assembly recited in claim 12, wherein each of the first fingers is axially aligned with a respective one of the slots.

16. The axial retention assembly recited in claim 1 wherein the ring section includes a first planer surface that faces in a first axial direction and a second planer surface that faces in a second axial direction,
each of the first fingers including a first planer surface that faces in the first axial direction and a second planer surface that faces in the second axial direction,
the first planar surface of each of the first fingers being contiguous with the first planar surface of the ring section,
the second planar surface of each of the second fingers being contiguous with the second planar surface of the ring section,
wherein the first planar surface of each of the first fingers and the first planar surface of the ring section extend in a first plane, and the second planar surface of each of the first fingers and the second planar surface of the ring section extend in a second plane.

17. A method for creating an axial retention assembly, the axial retention assembly including a retainer ring, a first part having a first circumferential surface and a second part having a second circumferential surface,
the retainer ring including a ring section, a set of first fingers each extending from the ring section radially in a first direction with respect to the center axis of the ring section; and a set of second fingers each extending from the ring section radially in the first direction with respect to the center axis of the ring section,
the method comprising:
installing the retainer ring onto the first part and the second part to cause the first fingers to snap into the first groove of the first part and to cause the second fingers to snap into the second groove of the second to prevent axial movement on both axial directions.

18. The method as recited in claim 17 wherein the retainer ring further includes a plurality of circumferentially spaced webs connected to the ring section, the second fingers being connected to the ring section by the webs,
the method further comprising:
stamping a steel sheet to form the ring section, the first fingers and the second fingers; and
bending the steel sheet to cause the second fingers to move axially with respect to the ring section and the first fingers the retainer ring to cause free ends of each of the second fingers to be axially spaced from free ends of the first fingers, the bending of the steel sheet including bending the steel sheet at a junction between the webs and the ring section.

19. A retainer ring for axial fixing a first part and a second part with respect to each other to prevent the second part from being movable in both axial directions with respect to the first part, the retainer comprising:
a ring section;
a set of first fingers each extending from the ring section radially in a first direction with respect to the center axis of the ring section; and
a set of second fingers each extending from the ring section radially in the first direction with respect to the center axis of the ring section,
free ends of each of the second fingers being axially spaced from free ends of the first fingers;
the free ends of the first fingers confirmed for being received in a first groove in a first circumferential surface of the first part,
the free ends of the second fingers confirmed for being received in a second groove in a second circumferential surface of the first part.

20. A method of constructing the retainer ring as recited in claim 19, the method comprising:
stamping a steel sheet to form the ring section, the first fingers and the second fingers; and
bending the steel sheet to cause the second fingers to move axially with respect to the ring section and the first fingers the retainer ring to cause free ends of each of the second fingers to be axially spaced from free ends of the first fingers.
